(19) United States
(12) Patent Application Publication
(10) Pub. No.: US 2017/0339366 A1
(43) Pub. Date: Nov. 23, 2017

(54) WIRELESS MICROPHONE SYSTEM

(71) Applicant: TRINUS SYSTEMS INC., Dong-gu, Daegu (KR)

(72) Inventor: Ki Hwan PARK, Goyang-si, Gyeonggi-do (KR)

(21) Appl. No.: 15/532,775

(22) PCT Filed: Dec. 14, 2014
(86) PCT No.: PCT/KR2014/011843

§ 371 Date: Jun. 2, 2017

(51) Int. Cl. H04N 5/60; H04N 5/765; G06F 3/16; H04R 1/08; H04R 3/00

(52) U.S. Cl. CPC H04N 5/60; H04R 1/08; H04R 3/00; G06F 3/165; H04N 5/765; H04R 2420/07

(57) ABSTRACT

The present invention relates to a wireless microphone system which, when recording voice data in an interval from a recording start time and a recording stop time, further records voice data by a predetermined period of time in the forward and backward directions of the recording start time and the recording stop time with reference to the time axis, thereby maximally securing voice data for identifying situations of various scenes such as an event, an accident and a criminal scene. The wireless microphone system according to the present invention comprises: a transmission unit for wirelessly transmitting voice data and a recording start signal; a reception unit for transmitting, to a reception target, the voice data and the recording start signal wirelessly transmitted from the transmission unit; and a DVR for temporarily storing the voice data transmitted from the reception unit in a first storage unit for a predetermined period of time, storing the voice data transmitted from the reception unit in a second storage unit and simultaneously storing voice data over a predetermined period of time before the point of reception of the recording start signal in the second storage unit using the voice data in the first storage unit when the recording start signal is received from the reception unit, and storing voice data over a predetermined period of time after the time when a recording stop signal is input through a recording stop signal input unit for stopping recording, included in the DVR.

### TECHNICAL FIELD

The present invention relates to a wireless microphone system, and more particularly, to a wireless microphone system capable of ensuring voice data sufficient to check circumstances of various scenes, e.g., an incident, accident, or crime scene, by recording voice data corresponding to a period from a recording start timing to a recording stop timing and further recording the voice data corresponding to preset periods before the recording start timing and after the recording stop timing on the basis of a time axis.

### BACKGROUND ART

In general, when accident and crime rates increase, the importance of accurately recording circumstances of scenes thereof also increases.

That is, human memories of incidents encountered in daily life may fade if not recorded as video data or voice data, and thus scenes thereof, which serve as critical clues, are damaged in many cases as time passes, if not recorded. Some circumstances of the scenes may become important later.

For example, before a suspect is detained, a police officer should tell the suspect why the suspect is being detained and give the suspect a Miranda warning. Arresting or confining a suspect without giving a Miranda warning is illegal, and assault on a police officer who illegally confines the suspect does not establish a case of obstruction of justice. In other words, detailed attitudes of the police officer toward the suspect may become an issue later in a trial process.

Accordingly, it is quite important to ensure accurate records on incident and accident scenes, e.g., a scene of arresting a suspect by police officers, a scene of rescuing people by a 119 rescue team, a scene of a major accident, and a scene of issuing tickets for parking violations.

For the above reason, wireless microphone recording devices installed in vehicles to obtain voice data of accident and crime scenes are provided.

However, the above-described typical wireless microphone recording devices normally record voice data corresponding to only a period from a timing when a user switches on a recording button to a timing when the user switches off the recording button. As such, voice data, which is very important to check circumstances of an incident or accident scene, is not appropriately stored in many cases.

That is, since the wireless microphone recording devices cannot always record voice data due to capacity limits thereof, users of the wireless microphone recording devices switch on a recording button to start to record the voice data in cases of emergency or necessity. However, since emergencies occur without warning, if a user recognizes an emergency and then switches on the recording button, actually required core voice data is not recorded.

In addition, since the typical wireless microphone recording devices can transmit, receive, and record voice data among previously set devices, when a major accident occurs and thus a plurality of wireless microphone recording devices are used, connection between devices may not be appropriately enabled, thereby causing inconvenience.

### DISCLOSURE

### Technical Problem

Therefore, the present invention has been made in view of the above problems, and it is one object of the present invention to provide a wireless microphone system capable of ensuring voice data sufficient to check circumstances of an incident or accident scene, by recording voice data corresponding to a period from a recording start timing to a recording stop timing and further recording the voice data corresponding to preset periods before the recording start timing and after the recording stop timing on the basis of a time axis.

It is another object of the present invention to provide a wireless microphone system capable of appropriately enabling connection between desired wireless microphone devices when an incident or accident occurs, and more particularly, when a major accident occurs and thus a plurality of wireless microphone devices are used, because settings for wireless transmission and reception between a portable transmitter and a receiver electrically connectable to the transmitter and fixed to a vehicle or the like are configurable based on one-touch ID exchange.

### Technical Solution

In accordance with one aspect of the present invention, provided is a wireless microphone system including a transmitter for wirelessly transmitting voice data and a recording start signal, a receiver for transmitting the voice data and the recording start signal, which are wirelessly transmitted from the transmitter, to a destination device, and a digital video recorder (DVR) for temporarily storing the voice data transmitted from the receiver in a first storage for a preset period, storing the voice data transmitted from the receiver in a second storage when the recording start signal is transmitted from the receiver, storing the voice data corresponding to a preset period before a reception timing of the recording start signal in the second storage using the voice data of the first storage, including a recording stop signal input unit for stopping recording of the voice data, and storing the voice data corresponding to a preset period after an input timing of a recording stop signal via the recording stop signal input unit in the second storage.

The DVR may combine the voice data of the period before the reception timing of the recording start signal and the voice data of the period after the input timing of the recording stop signal, to front and rear parts of the voice data of the period between the reception timing of the recording start signal and the input timing of the recording stop signal on the basis of a time axis, respectively, thereby storing the combined voice data as a single voice file.

Assuming that an operation of storing the voice data corresponding to the preset period before the reception timing of the recording start signal by the DVR in the second storage is referred to as pre-recording, an operation of storing the voice data corresponding to the preset period after the input timing of the recording stop signal to the DVR in the second storage is referred to as post-recording, and an operation of storing the voice data corresponding to a period from the reception timing of the recording start signal to the input timing of the recording stop signal in the second storage is referred to as regular recording, when a new recording start signal is transmitted from the receiver during a current post-recording period, the DVR may start regular recording based on the new recording start signal immediately after the current post-recording period is completed.

When a new recording start signal is transmitted from the receiver during a current post-recording period, the DVR continuously performs post-recording and, at the same time, performs pre-recording based on the new recording start signal by a preset period before a transmission timing of the new recording start signal.

The transmitter and the receiver may individually include connection terminals for electrical connection therebetween to configure settings for wireless transmission and reception between the transmitter and the receiver when the connection terminals are connected to each other,

The transmitter may have a unique identifier (ID) and transmit the unique ID to the receiver when connected to the receiver via the connection terminals, and the receiver may include a storage for storing the unique ID of the transmitter and store the unique ID of the transmitter in the storage when the unique ID is transmitted from the transmitter, to configure settings for wireless transmission and reception to and from the transmitter.

The transmitter may have a unique identifier (ID) and transmit the unique ID to the receiver when connected to the receiver via the connection terminals, and the receiver may include a database having stored therein unique IDs of a plurality of transmitters and authenticate the unique ID of the transmitter by determining whether the unique ID is valid, using the database when the unique ID is transmitted from the transmitter, to configure settings for wireless transmission and reception to and from the transmitter having the authenticated unique ID.

The receiver may have stored therein a plurality of unique identifiers (IDs) to be individually assigned to a plurality of transmitters, and the transmitter may receive a unique ID assigned thereto from the receiver when connected to the receiver via the connection terminals, to configure settings for wireless transmission and reception to and from the receiver.

The receiver may include a code generator for generating a unique identifier (ID) to be assigned to the transmitter, and generate and transmit a unique ID to the transmitter whenever the transmitter is connected thereto via the connection terminals, and the transmitter may store the unique ID transmitted from the receiver, to configure settings for wireless transmission and reception to and from the receiver.

Charging power may be supplied via the receiver to the transmitter when the transmitter and the receiver are connected to each other via the connection terminals.

Wireless transmission and reception may be enabled between a single receiver and multiple transmitters via multiple channels.

Each of the transmitter and the receiver may have a standby mode and thus normally operate in the standby mode and be switched to an operation mode corresponding to a power on state to transmit or receive signals and data.

The transmitter may include one or more of a TALK button for transmitting the voice data and allowing the DVR to start to record the voice data, a MODE button for switching between four modes of LED/VIBRATION/LED&VIBRATION/NONE, a MUTE button for muting the voice data, and LED indicators for indicating operation statuses.

The receiver may include LEDs for indicating whether the voice data is being recorded, and indicating a battery charge status.

The receiver may transmit a control signal transmitted from the DVR, to the transmitter.

The transmitter may always transmit the voice data to the receiver in a power on state.

The transmitter may include a video recording start signal as well as an audio recording start signal, and a video recording stop signal as well as an audio recording stop signal in the recording start signal and the recording stop signal to be transmitted to the receiver, and the DVR may start and stop audio and video recording operations based on the recording start signal and the recording stop signal transmitted from the transmitter via the receiver.

The transmitter may also have a function of wirelessly transmitting the recording stop signal, and the DVR may store the voice data corresponding to the preset period after the reception timing of the recording stop signal via the receiver from the transmitter in the second storage.

### Advantageous Effects

As apparent from the fore-going, voice data sufficient to check circumstances of an incident or accident scene may be ensured by recording voice data corresponding to a period from a recording start timing to a recording stop timing and further recording the voice data corresponding to preset periods before the recording start timing and after the recording stop timing on the basis of a time axis.

Connection between desired wireless microphone devices may be appropriately enabled when an incident or accident occurs, and more particularly, when a major accident occurs and thus a plurality of wireless microphone devices are used, because settings for wireless transmission and reception between a portable transmitter and a receiver electrically connectable to the transmitter and fixed to a vehicle or the like are configurable based on one-touch ID exchange.

### DESCRIPTION OF DRAWINGS

FIG. 1 is a block diagram of a wireless microphone system according to an embodiment of the present invention.

FIG. 2 is a perspective view of a transmitter and a receiver of the wireless microphone system according to an embodiment of the present invention.

FIG. 3 is a flowchart of an example of a voice data recording operation of the wireless microphone system according to an embodiment of the present invention.

FIG. 4 is a conceptual view showing an example of recording voice data by the wireless microphone system according to an embodiment of the present invention.

FIGS. 5 and 6 are conceptual views showing other examples of recording voice data by the wireless microphone system according to an embodiment of the present invention.

FIGS. 7 to 10 are views showing examples of configuring settings for wireless transmission and reception between the transmitter and the receiver of the wireless microphone system according to an embodiment of the present invention.

### BEST MODE

Hereinafter, the present invention will be described in detail by explaining embodiments of the invention with reference to the attached drawings.

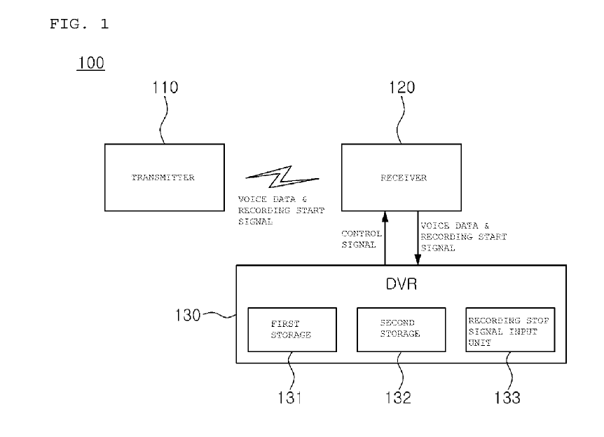

FIG. 1 is a block diagram of a wireless microphone system 100 according to an embodiment of the present invention.

As illustrated in FIG. 1, the wireless microphone system 100 according to an embodiment of the present invention includes a transmitter 110, a receiver 120, and a digital video recorder (DVR) 130.

The transmitter 110 is a portable device and wirelessly transmits voice data of a user and a recording start signal to the receiver 120. That is, the transmitter 110 includes a wireless communication module, and wirelessly transmits and receives various types of data and electrical signals to and from the receiver 120 using the wireless communication module. In this case, the transmitter 110 may always transmit the voice data to the receiver 120 in a power on state.

The transmitter 110 transmits the recording start signal to the receiver 120 in such a manner that the transmitted voice data of the user is transmitted via the receiver 120 to and recorded by the DVR 130. In this case, the transmitter 110 may include a video recording start signal as well as an audio recording start signal in the recording start signal to be transmitted to the receiver 120. As such, the DVR 130 starts and stops audio and video recording operations based on the recording start signal transmitted from the transmitter 110 via the receiver 120.

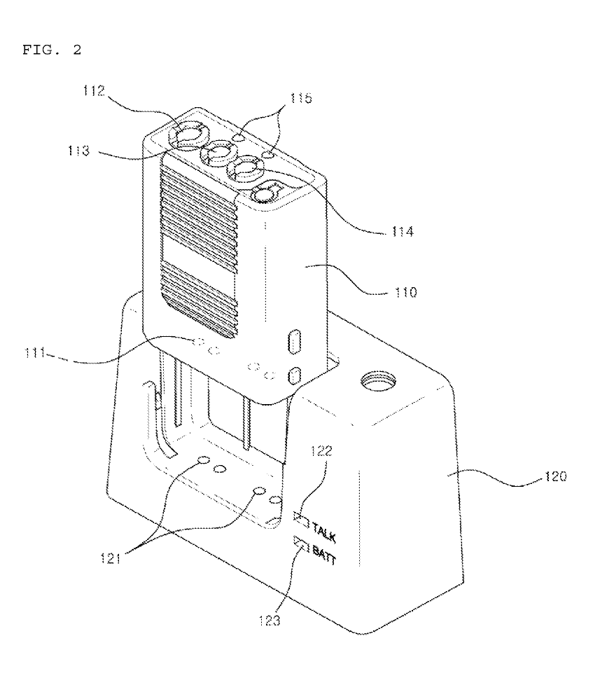

The transmitter 110 will now be described in detail with reference to FIG. 2. As illustrated in FIG. 2, the transmitter 110 includes a TALK button 112 for transmitting the voice data and allowing the DVR 130 to record the voice data, a MODE button 113 for switching between four modes of LED/VIBRATION/LED&VIBRATION/NONE, a MUTE button 114 for muting the voice data, and LED indicators 115 for indicating operation statuses.

Although the transmitter 110 includes the MODE button 113, the MUTE button 114, and the LED indicators 115 as well as the TALK button 112 in the current embodiment, the present invention is not limited thereto and the transmitter 110 may essentially include the TALK button 112 and selectively include the MODE button 113, the MUTE button 114, and the LED indicators 115.

Referring back to FIG. 1, the receiver 120 transmits the voice data and the recording start signal, which are wirelessly transmitted from the transmitter 110, to the DVR 130. In addition, the receiver 120 transmits a control signal transmitted from the DVR 130, to the transmitter 110.

The receiver 120 will now be described in detail with reference to FIG. 2. The receiver 120 includes a recording status indicator LED 122 for indicating whether the voice data is being recorded, and a charge status indicator LED 123 for indicating a battery charge status.

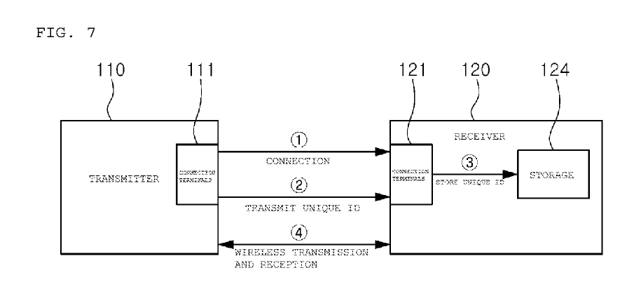

In the current embodiment, the receiver 120 is configured as a docking stand capable of supporting the transmitter 110, and thus the transmitter 110 is docked with the receiver 120. In this case, the transmitter 110 and the receiver 120 may individually include connection terminals 111 and 121 for electrical connection therebetween to configure settings for wireless transmission and reception between the transmitter 110 and the receiver 120 when the connection terminals 111 and 121 are connected to each other. A detailed description thereof will be provided below with reference to FIGS. 7 to 10.

Referring back to FIG. 1, the DVR 130 includes a first storage 131, a second storage 132, and a recording stop signal input unit 133. The first storage 131 temporarily stores the voice data transmitted from the receiver 120, for a preset period, and the second storage 132 permanently stores the voice data transmitted from the receiver 120, without data deletion based on the recording start signal transmitted from the receiver 120.

In this case, the DVR 130 stores the voice data in the second storage 132 from a timing before a reception timing of the recording start signal by a preset period, using a temporary storage function of the first storage 131.

When a recording stop signal is input from the recording stop signal input unit 133, the DVR 130 stores the voice data until a timing after an input timing of the recording stop signal by a preset period.

In other words, when the recording start signal and the recording stop signal are transmitted and input from the receiver 120 and the recording stop signal input unit 133 to the DVR 130 at different timings, the DVR 130 stores the voice data corresponding to a preset period before the reception timing of the recording start signal in the second storage 132 using the voice data of the first storage 131, and stores the voice data corresponding to a preset period after the input timing of the recording stop signal in the second storage 132. In this case, the DVR 130 may combine the voice data of the period before the reception timing of the recording start signal and the voice data of the period after the input timing of the recording stop signal, to front and rear parts of the voice data of a period between the reception timing of the recording start signal and the input timing of the recording stop signal on the basis of a time axis, respectively, thereby storing the combined voice data as a single voice file.

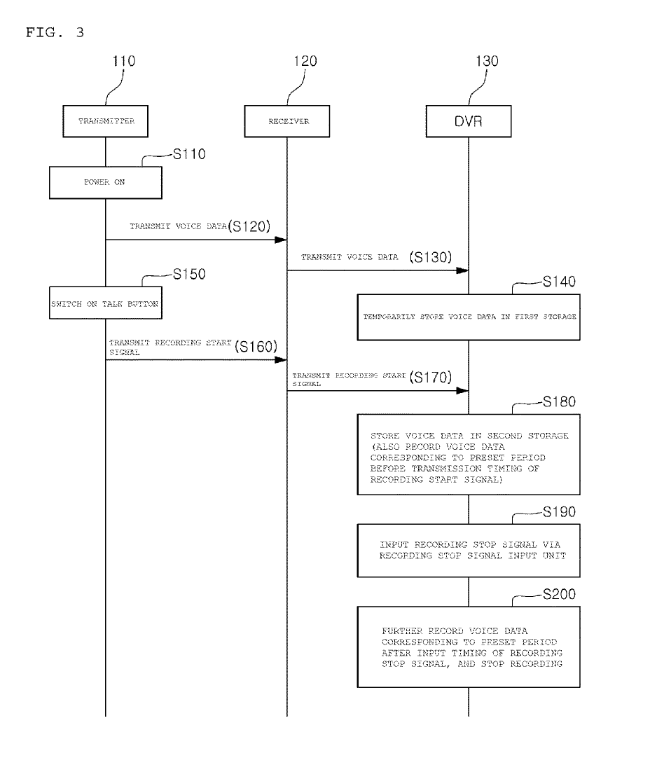

FIG. 3 is a flowchart of an example of a voice data recording operation of the wireless microphone system 100 according to an embodiment of the present invention.

Referring to FIG. 3, in step S110, the transmitter 110 is powered on.

In step S120, the transmitter 110 transmits obtained voice data of a user to the receiver 120. In other words, the transmitter 110 continuously obtains the voice data of the user and an ambient environment and continuously transmits the obtained voice data to the receiver 120, in a power on state.

In step S130, the receiver 120 transmits the voice data received from the transmitter 110, to the DVR 130.

In step S140, the DVR 130 temporarily stores the voice data transmitted from the receiver 120 in the first storage 131 for a preset period.

In step S150, the TALK button 112 of the transmitter 110 is switched on.

In step S160, as the TALK button 112 is switched on in step S150, a recording start signal is transmitted to the receiver 120.

In step S170, as the recording start signal is received from the transmitter 110, the receiver 120 transmits the recording start signal to the DVR 130.

In step S180, the DVR 130 stores the voice data transmitted from the receiver 120 in the second storage 132. In this case, the DVR 130 detects the voice data of a preset period before the reception timing of the recording start signal, from the first storage 131 using a temporary storage function of the first storage 131, and combines the detected voice data to a front part of the voice data stored in the second storage 132, on the basis of a time axis, thereby storing the combined voice data as a single voice file.

In step S190, a recording stop signal is input via the recording stop signal input unit 133 of the DVR 130.

In step S200, the DVR 130 stops recording of the voice data, which started to be recorded in step S180, based on the recording stop signal input from the recording stop signal input unit 133. In this case, the DVR 130 further records the voice data for a preset period after an input timing of the recording stop signal, and then stops recording of the voice data.

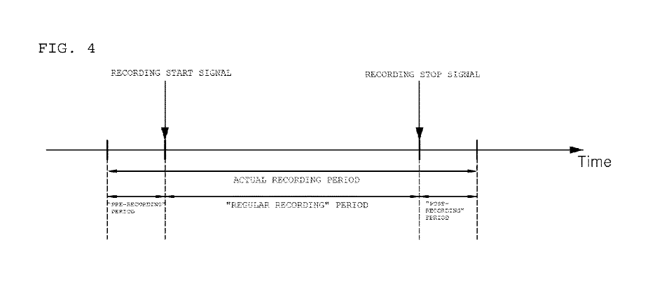

FIG. 4 is a conceptual view showing an example of recording voice data by the wireless microphone system 100 according to an embodiment of the present invention.

Before explanation, an operation of storing voice data corresponding to a preset period before a reception timing of a recording start signal by the DVR 130 in the second storage 132 is referred to as “pre-recording”, an operation of storing the voice data corresponding to a preset period after an input timing of a recording stop signal to the DVR 130 in the second storage 132 is referred to as “post-recording”, and an operation of storing the voice data corresponding to a period from the reception timing of the recording start signal to the input timing of the recording stop signal in the second storage 132 is referred to as “regular recording”. The above definitions are applied to the following descriptions of FIGS. 4, 5, and 6.

As illustrated in FIG. 4, the DVR 130 further records the voice data at a front side of a time axis on the basis of a timing when a recording start signal is received from the receiver 120, i.e., a timing when the TALK button 112 of the transmitter 110 is switched on, by a preset period (e.g., a prerecord period). That is, the DVR 130 records the voice data corresponding to a pre-recording period. In addition, the DVR 130 further records the voice data at a rear side of the time axis on the basis of a timing when a recording stop signal is received from the recording stop signal input unit 133, by a preset period (e.g., a postrecord time). That is, the DVR 130 records the voice data corresponding to a post-recording period. As such, an actual recording period of the DVR 130 corresponds to a sum of the pre-recording period, a regular recording period, and the post-recording period.

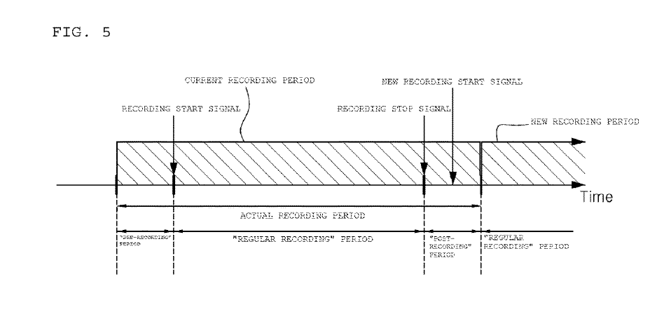

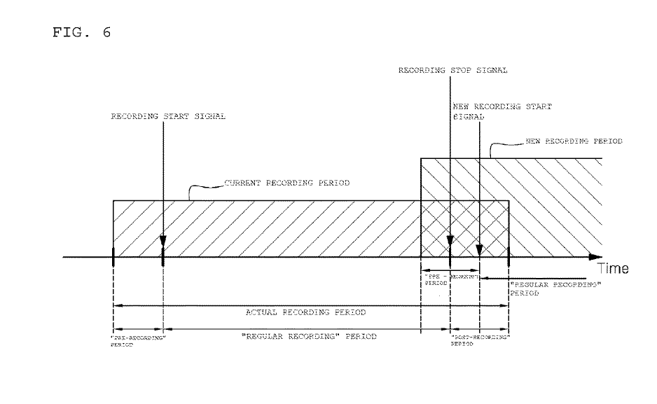

Other examples of recording voice data by the wireless microphone system 100 according to an embodiment of the present invention will now be described with reference to FIGS. 5 and 6.

FIGS. 5 and 6 are conceptual views showing other examples of recording voice data by the wireless microphone system 100 according to an embodiment of the present invention.

Referring to FIG. 5, when a new recording start signal is transmitted from the receiver 120 during a current post-recording period, the DVR 130 starts regular recording based on the new recording start signal immediately after the current post-recording period is completed. That is, a new recording period based on the new recording start signal does not include a pre-recording period but starts with a regular recording period.

Referring to FIG. 6, when a new recording start signal is transmitted from the receiver 120 during a current post-recording period, the DVR 130 continuously performs post-recording and, at the same time, performs pre-recording based on the new recording start signal by a preset period before a transmission timing of the new recording start signal. That is, a previous recording period being processed before the transmission timing of the new recording start signal is finished after post-recording is normally completed, and a subsequent recording period to be processed based on the transmission timing of the new recording start signal proceeds to regular recording after pre-recording is normally completed. Consequently, an overlapping recording period is present between the previous recording period and the subsequent recording period on the basis of the transmission timing of the new recording start signal.

Due to the above-described configuration, if a user of the wireless microphone system 100 manipulates the TALK button 112 of the transmitter 110 to start a recording operation of the DVR 130 and then manipulates the recording stop signal input unit 133 of the DVR 130 to stop the recording operation of the DVR 130 in a case of emergency or necessity, voice data corresponding to a predetermined period before a timing when the user actually manipulates to switch on the TALK button 112 is also recorded and, at the same time, the voice data corresponding to a predetermined period after a timing when the user actually manipulates the recording stop signal input unit 133 is also recorded. As such, the voice data of the case may be obtained for a longer period and thus may be effectively used to analyze and check the case.

Examples of configuring settings for wireless transmission and reception between the transmitter 110 and the receiver 120 of the wireless microphone system 100 according to an embodiment of the present invention will now be described with reference to FIGS. 7 to 10.

Referring to FIG. 7, when the transmitter 110 is supported by the receiver 120, the connection terminals 111 of the transmitter 110 and the connection terminals 121 of the receiver 120 are connected to each other. Due to connection between the transmitter 110 and the receiver 120, a unique identifier (ID) of the transmitter 110 is transmitted to the receiver 120. That is, the transmitter 110 has a unique ID and transmits the unique ID to the receiver 120 when connected to the receiver 120 via the connection terminals 111 and 121. As such, the receiver 120 stores the received unique ID of the transmitter 110 in a storage 124 and thus settings for wireless transmission and reception between the receiver 120 and the transmitter 110 are configured.

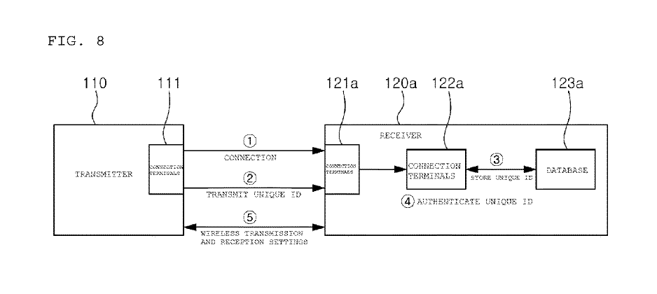

Referring to FIG. 8, when the transmitter 110 is supported by a receiver 120a, the connection terminals 111 of the transmitter 110 and connection terminals 121a of the receiver 120a are connected to each other. Due to connection between the transmitter 110 and the receiver 120a, a unique ID of the transmitter 110 is transmitted to the receiver 120a. In this case, the receiver 120a includes a database 123a having stored therein unique IDs of a plurality of transmitters 110, and an authenticator 122a authenticates the received unique ID of the transmitter 110 by determining whether the unique ID is detected in the database 123a. If the unique ID is authenticated by the authenticator 122a, settings for wireless transmission and reception between the transmitter 110 and the receiver 120a are configured.

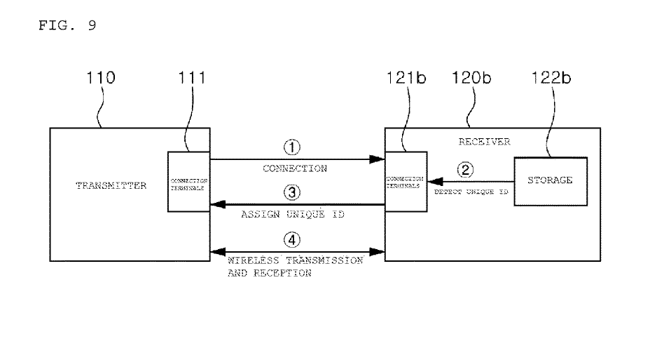

Referring to FIG. 9, when the transmitter 110 is supported by a receiver 120b, the connection terminals 111 of the transmitter 110 and connection terminals 121b of the receiver 120b are connected to each other. As such, the receiver 120b detects one of a plurality of unique IDs stored in a storage 122b and then assigns the detected unique ID to the transmitter 110. To this end, the receiver 120b has stored in the storage 122b a plurality of unique IDs to be individually assigned to a plurality of transmitters 110. If the unique ID is assigned to the transmitter 110 from the receiver 120b, settings for wireless transmission and reception between the transmitter 110 and the receiver 120b are configured.

A unique ID may be assigned to the transmitter 110 from the same or different receiver whenever connected to the receiver, or may be assigned to the transmitter 110 from a different receiver whenever connected to the receiver.

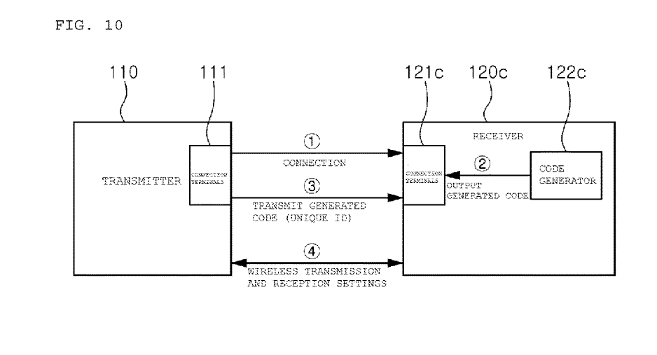

Referring to FIG. 10, when the transmitter 110 is supported by a receiver 120c, the connection terminals 111 of the transmitter 110 and connection terminals 121c of the receiver 120c are connected to each other. As such, the receiver 120c generates a unique ID using a code generator 122c and then outputs the generated unique ID to the connection terminals 121c. In this case, the receiver 120c generates a unique ID using the code generator 122c whenever the transmitter 110 is connected thereto via the connection terminals 111. Then, the receiver 120c transmits and assigns the unique ID output from the code generator 122c, to the transmitter 110. If the unique ID is assigned to the transmitter 110 from the receiver 120c, settings for wireless transmission and reception between the transmitter 110 and the receiver 120c are configured.

Other configurations of the wireless microphone system 100 according to an embodiment of the present invention will now be described with reference to FIGS. 1 and 2.

Charging power may be supplied via the receiver 120 to the transmitter 110 when the transmitter 110 and the receiver 120 are connected to each other via the connection terminals 111 and 121.

Wireless transmission and reception may be enabled between a single receiver 120 and multiple transmitters 110 via multiple channels.

Each of the transmitter 110 and the receiver 120 may have a standby mode and thus may normally operate in the standby mode and be switched to an operation mode corresponding to a power on state when a signal or data is received.

The transmitter 110 may also have a function of wirelessly transmitting the recording stop signal, and the DVR 130 may store the voice data corresponding to the preset period after the reception timing of the recording stop signal via the receiver 120 from the transmitter 110 in the second storage 132.

According to the current embodiment, the receiver 120 and the DVR 130 may be installed in a police car and thus the wireless microphone system 100 may be used for patrol, crime prevention, inspection, arrest of criminals, etc. However, the present invention is not limited thereto and the wireless microphone system 100 according to the present invention may be commonly applied to various fields requiring recording of voice data.

As described above in relation to FIGS. 1 to 10, a wireless microphone system according to the present invention may ensure voice data sufficient to check circumstances of an incident or accident scene by recording voice data corresponding to a period from a recording start timing to a recording stop timing and further recording the voice data corresponding to preset periods before the recording start timing and after the recording stop timing on the basis of a time axis.

In addition, connection between desired wireless microphone devices may be appropriately enabled when an incident or accident occurs, and more particularly, when a major accident occurs and thus a plurality of wireless microphone devices are used, because settings for wireless transmission and reception between a portable transmitter and a receiver electrically connectable to the transmitter and fixed to a vehicle or the like are configurable based on one-touch ID exchange.

While the present invention has been particularly shown and described with reference to embodiments thereof, it will be understood by one of ordinary skill in the art that various changes in form and details may be made therein without departing from the spirit and scope of the present invention as defined by the following claims.

### INDUSTRIAL APPLICABILITY

The present invention may be used for a variety of microphone systems.

1. A wireless microphone system comprising:
a transmitter for wirelessly transmitting voice data and a recording start signal;
a receiver for transmitting the voice data and the recording start signal, which are wirelessly transmitted from the transmitter, to a destination device; and
a digital video recorder (DVR) for temporarily storing the voice data transmitted from the receiver in a first storage for a preset period, storing the voice data transmitted from the receiver in a second storage when the recording start signal is transmitted from the receiver, storing the voice data corresponding to a preset period before a reception timing of the recording start signal in the second storage using the voice data of the first storage, comprising a recording stop signal input unit for stopping recording of the voice data, and storing the voice data corresponding to a preset period after an input timing of a recording stop signal via the recording stop signal input unit in the second storage,
wherein, assuming that an operation of storing the voice data corresponding to the preset period before the reception timing of the recording start signal by the DVR in the second storage is referred to as pre-recording, an operation of storing the voice data corresponding to the preset period after the input timing of the recording stop signal to the DVR in the second storage is referred to as post-recording, and an operation of storing the voice data corresponding to a period from the reception timing of the recording start signal to the input timing of the recording stop signal in the second storage is referred to as regular recording, when a new recording start signal is transmitted from the receiver during a current post-recording period, the DVR starts regular recording based on the new recording start signal immediately after the current post-recording period is completed.

2. A wireless microphone system comprising:
a transmitter for wirelessly transmitting voice data and a recording start signal;
a receiver for transmitting the voice data and the recording start signal, which are wirelessly transmitted from the transmitter, to a destination device; and
a digital video recorder (DVR) for temporarily storing the voice data transmitted from the receiver in a first storage for a preset period, storing the voice data transmitted from the receiver in a second storage when the recording start signal is transmitted from the receiver, storing the voice data corresponding to a preset period before a reception timing of the recording start signal in the second storage using the voice data of the first storage, comprising a recording stop signal input unit for stopping recording of the voice data, and storing the voice data corresponding to a preset period after an input timing of a recording stop signal via the recording stop signal input unit in the second storage,
wherein, assuming that an operation of storing the voice data corresponding to the preset period before the reception timing of the recording start signal by the DVR in the second storage is referred to as pre-recording, an operation of storing the voice data corresponding to the preset period after the input timing of the recording stop signal to the DVR in the second storage is referred to as post-recording, and an operation of storing the voice data corresponding to a period from the reception timing of the recording start signal to the input timing of the recording stop signal in the second storage is referred to as regular recording, when a new recording start signal is transmitted from the receiver during a current post-recording period, the DVR continuously performs post-recording and, at the same time, performs pre-recording based on the new recording start signal by a preset period before a transmission timing of the new recording start signal.

3. A wireless microphone system comprising:
a transmitter for wirelessly transmitting voice data and a recording start signal;
a receiver for transmitting the voice data and the recording start signal, which are wirelessly transmitted from the transmitter, to a destination device; and
a digital video recorder (DVR) for temporarily storing the voice data transmitted from the receiver in a first storage for a preset period, storing the voice data transmitted from the receiver in a second storage when the recording start signal is transmitted from the receiver, storing the voice data corresponding to a preset period before a reception timing of the recording start signal in the second storage using the voice data of the first storage, comprising a recording stop signal input unit for stopping recording of the voice data, and storing the voice data corresponding to a preset period after an input timing of a recording stop signal via the recording stop signal input unit in the second storage,
wherein the transmitter and the receiver individually comprise connection terminals for electrical connection therebetween to configure settings for wireless transmission and reception between the transmitter and the receiver when the connection terminals are connected to each other,
wherein the transmitter has a unique identifier (ID) and transmits the unique ID to the receiver when connected to the receiver via the connection terminals, and
wherein the receiver comprises a storage for storing the unique ID of the transmitter and stores the unique ID of the transmitter in the storage when the unique ID is transmitted from the transmitter, to configure settings for wireless transmission and reception to and from the transmitter.

4. A wireless microphone system comprising:
a transmitter for wirelessly transmitting voice data and a recording start signal;
a receiver for transmitting the voice data and the recording start signal, which are wirelessly transmitted from the transmitter, to a destination device; and
a digital video recorder (DVR) for temporarily storing the voice data transmitted from the receiver in a first storage for a preset period, storing the voice data transmitted from the receiver in a second storage when the recording start signal is transmitted from the receiver, storing the voice data corresponding to a preset period before a reception timing of the recording start signal in the second storage using the voice data of the first storage, comprising a recording stop signal input unit for stopping recording of the voice data, and storing the voice data corresponding to a preset period after an input timing of a recording stop signal via the recording stop signal input unit in the second storage,
wherein the transmitter and the receiver individually comprise connection terminals for electrical connection therebetween to configure settings for wireless transmission and reception between the transmitter and the receiver when the connection terminals are connected to each other,
wherein the transmitter has a unique identifier (ID) and transmits the unique ID to the receiver when connected to the receiver via the connection terminals, and
wherein the receiver comprises a database having stored therein unique IDs of a plurality of transmitters and authenticates the unique ID of the transmitter by determining whether the unique ID is valid, using the database when the unique ID is transmitted from the transmitter, to configure settings for wireless transmission and reception to and from the transmitter having the authenticated unique ID.

5. A wireless microphone system comprising:
a transmitter for wirelessly transmitting voice data and a recording start signal;
a receiver for transmitting the voice data and the recording start signal, which are wirelessly transmitted from the transmitter, to a destination device; and
a digital video recorder (DVR) for temporarily storing the voice data transmitted from the receiver in a first storage for a preset period, storing the voice data transmitted from the receiver in a second storage when the recording start signal is transmitted from the receiver, storing the voice data corresponding to a preset period before a reception timing of the recording start signal in the second storage using the voice data of the first storage, comprising a recording stop signal input unit for stopping recording of the voice data, and storing the voice data corresponding to a preset period after an input timing of a recording stop signal via the recording stop signal input unit in the second storage,
wherein the transmitter and the receiver individually comprise connection terminals for electrical connection therebetween to configure settings for wireless transmission and reception between the transmitter and the receiver when the connection terminals are connected to each other,
wherein the receiver has stored therein a plurality of unique identifiers (IDs) to be individually assigned to a plurality of transmitters, and
wherein the transmitter receives a unique ID assigned thereto from the receiver when connected to the receiver via the connection terminals, to configure settings for wireless transmission and reception to and from the receiver.

6. A wireless microphone system comprising:
a transmitter for wirelessly transmitting voice data and a recording start signal;
a receiver for transmitting the voice data and the recording start signal, which are wirelessly transmitted from the transmitter, to a destination device; and
a digital video recorder (DVR) for temporarily storing the voice data transmitted from the receiver in a first storage for a preset period, storing the voice data transmitted from the receiver in a second storage when the recording start signal is transmitted from the receiver, storing the voice data corresponding to a preset period before a reception timing of the recording start signal in the second storage using the voice data of the first storage, comprising a recording stop signal input unit for stopping recording of the voice data, and storing the voice data corresponding to a preset period after an input timing of a recording stop signal via the recording stop signal input unit in the second storage,
wherein the transmitter and the receiver individually comprise connection terminals for electrical connection therebetween to configure settings for wireless transmission and reception between the transmitter and the receiver when the connection terminals are connected to each other,
wherein the receiver comprises a code generator for generating a unique identifier (ID) to be assigned to the transmitter, and generates and transmits a unique ID to the transmitter whenever the transmitter is connected thereto via the connection terminals, and
wherein the transmitter stores the unique ID transmitted from the receiver, to configure settings for wireless transmission and reception to and from the receiver.

7. The wireless microphone system according to claim 1, wherein the transmitter and the receiver individually comprise connection terminals for electrical connection therebetween to configure settings for wireless transmission and reception between the transmitter and the receiver when the connection terminals are connected to each other.

8. The wireless microphone system according to claim 7, wherein charging power is supplied via the receiver to the transmitter when the transmitter and the receiver are connected to each other via the connection terminals.

9. The wireless microphone system according to claim 1, wherein the DVR combines the voice data of the period before the reception timing of the recording start signal and the voice data of the period after the input timing of the recording stop signal, to front and rear parts of the voice data of the period between the reception timing of the recording start signal and the input timing of the recording stop signal on the basis of a time axis, respectively, thereby storing the combined voice data as a single voice file.

10. The wireless microphone system according to claim 1, wherein wireless transmission and reception are enabled between a single receiver and multiple transmitters via multiple channels.

11. The wireless microphone system according to claim 1, wherein each of the transmitter and the receiver has a standby mode and thus normally operates in the standby mode and is switched to an operation mode corresponding to a power on state to transmit or receive signals and data.

12. The wireless microphone system according to claim 1, wherein the transmitter comprises one or more of:
a TALK button for transmitting the voice data and allowing the DVR to start to record the voice data;
a MODE button for switching between four modes of LED/VIBRATION/LED&VIBRATION/NONE;
a MUTE button for muting the voice data; and
LED indicators for indicating operation statuses.

13. The wireless microphone system according to claim 1, wherein the receiver comprises LEDs for indicating whether the voice data is being recorded, and indicating a battery charge status.

14. The wireless microphone system according to claim 1, wherein the receiver transmits a control signal transmitted from the DVR, to the transmitter.

15. The wireless microphone system according to claim 1, wherein the transmitter always transmits the voice data to the receiver in a power on state.

16. The wireless microphone system according to claim 1, wherein the transmitter includes a video recording start signal as well as an audio recording start signal, and a video recording stop signal as well as an audio recording stop signal in the recording start signal and the recording stop signal to be transmitted to the receiver, and
wherein the DVR starts and stops audio and video recording operations based on the recording start signal and the recording stop signal transmitted from the transmitter via the receiver.

17. The wireless microphone system according to claim 1, wherein the transmitter also has a function of wirelessly transmitting the recording stop signal, and
wherein the DVR stores the voice data corresponding to the preset period after the reception timing of the recording stop signal via the receiver from the transmitter in the second storage.
